(19) United States
(12) Patent Application Publication
(10) Pub. No.: US 2008/0044081 A1
(43) Pub. Date: Feb. 21, 2008

(54) COLOR INDEXING FOR IMAGES

(76) Inventor: Adam Lieb, San Francisco, CA (US)

Correspondence Address: PERKINS COIE LLP, P.O. BOX 2168, MENLO PARK, CA, 94026, US

(21) Appl. No.: 11/539,624

(22) Filed: Oct. 6, 2006

Related U.S. Application Data
(60) Provisional application No. 60/823,095, filed on Aug. 21, 2006.

(51) Int. Cl. G06K 9/00

(52) U.S. Cl. 382/162; 382/118; 382/305

(57) ABSTRACT

In one embodiment, a method is presented. The method includes receiving image data for an image. The method further includes inventorying color values of the image data. The method also includes assigning color values of the image data to a set of predetermined precise color values. The method includes storing a list of precise color values with data indicating a source of the image data.

### CLAIM OF PRIORITY

This application claims priority to U.S. Provisional Patent Application No. 60/823,095, filed on Aug. 21, 2006, which is hereby incorporated herein by reference.

### BACKGROUND

Millions of products are currently available for sale on the World Wide Web. A number of websites organize these products into large online stores and provide a variety of tools to enable consumers to find products that interest them. The existing technologies work especially well for “structured” products (i.e. well known, commonly sold products with a shared SKU/UPC number—like electronics). However, the existing technology does not work as well for “unstructured” products, like apparel, shoes, bags, etc. These “fuzzy” products are hard for the online shopping storefronts to describe (in terms of data-fields), categorize, and aggregate (i.e. recognize when more then one of their vendors are selling the same product). As such, consumers have fewer tools available for finding products that interest them within a specific product category, and the large stores have a harder time advertising these product lines across their affiliate/advertising networks.

In particular, searching for colors in images is difficult using today's search engine technologies. For example, when a shopper wants to find a red bag, the shopper either has to search for products with textual descriptions suggesting a red bag, or visually scan through images of products to find the desired red bag.

Some basic approaches have been taken in an attempt to solve this problem. One approach is to have human editors manually label images or products and then to search on the keywords of the labels. Thus, a bag may be described by a manufacturer, and depicted as a red bag. Or, a merchandiser may then add a keyword to a webpage for the product indicating the bag is red (or whatever other color is appropriate). Given the number and nuances of colors contained in each image, and the costs associated with tagging a large number of images, this solution has proved ineffective.

Some basic progress has been made in systems that automatically indexes colors in an image. However, these solutions have met with limited success, since they are often unable to factor out colors which are not associated with the target object (backgrounds, model's skintone, etc), are only able to select one color per image, and in general have accuracy issues. Also, existing solutions use a color-wheel or other similar means for the end-user to graphically pinpoint a very specific, single-color selection as the primary user-interface. This does not work seamlessly with the most commonly used search method (namely, keyword-based search), provides no feedback for which colors are the most popular, and does not allow users to browse and select among general or commonly-used colors (like “Red”).

Thus, what may be useful is to provide a system which can, with a high-degree of accuracy, automatically index multiple colors from each image in a set of images and then allow users to either search images using color-related keywords or browse by selecting from lists of colors which commonly appear in the image catalog.

### BRIEF DESCRIPTION OF THE DRAWINGS

The present invention is illustrated by way of example in the accompanying drawings. The drawings should be understood as illustrative rather than limiting.

FIG. 1 illustrates an embodiment of a system including color search capabilities.

FIG. 2 illustrates another embodiment of a system including color search capabilities.

FIG. 3 illustrates an embodiment of a system for implementing color search capabilities.

FIG. 4 illustrates an embodiment of a process of collecting color data from images.

FIG. 5 illustrates an embodiment of a process of searching color data.

FIG. 6 illustrates an embodiment of machine-readable media which embody a system for collecting and searching color data.

FIG. 7 illustrates an embodiment of a network of systems which may be used in conjunction with color search systems and processes.

FIG. 8 illustrates an embodiment of a computer or similar machine which may be used in the network of FIG. 7 and may also be used to implement a color search system or process.

FIG. 9 illustrates results of color data collection and searching in some embodiments.

FIG. 10 illustrates a set of common colors for browsing in some embodiments.

FIG. 11 illustrates another set of related colors for browsing in some embodiments.

FIG. 12 illustrates an embodiment of a process of searching for an image.

FIG. 13 illustrates an embodiment of a user interface displaying images in a color search system.

FIG. 14 illustrates the embodiment of FIG. 13 after a refined search.

FIG. 15 illustrates another embodiment of a process of searching for an image.

### DETAILED DESCRIPTION

A system, method and apparatus is provided for color indexing, mapping and searching. The specific embodiments described in this document represent examples or embodiments of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Features and aspects of various embodiments may be integrated into other embodiments, and embodiments illustrated in this document may be implemented without all of the features or aspects illustrated or described.

In some embodiments, a system or process enables a new means of searching images using color. In the retail space, it is potentially useful for color-sensitive product categories (e.g. apparel, shoes, bags, artwork, jewelry, etc.) In other spaces, it may be useful to searching images of various different types, such as file photographs or images of species of plants or animals, for example.

In some embodiments, there are two parts to the process. One such embodiment is described immediately below. The first part involves indexing images. The second part involves searching the images.

For indexing, in some embodiments, the system takes a large number of images as input. (No other structured data besides the image itself is needed). The system analyzes each image to determine a small (generally 1-6) set of colors which best describes the image.

The system uses several algorithms to enable it, with a relatively high degree of accuracy, to filter out: (a) background colors (solid backgrounds, gradients, and even highly photographic backgrounds not related to the primary object) (b) models (i.e. skin tones/mannequins), and (c) shadows/shading. Also, the system can handle multiple instances of a particular product (but with different colors) in the same image.

Each resulting color is assigned a score, based on a number of factors (including the amount of color in the source image, the average pixel position of that color, etc). Finally, each color is mapped to one-or-more colors using one-or-more “color maps” (predefined discreet sets of colors) using an algorithm, and the resulting information is stored in a database.

Given the above index, shoppers or searchers can now search the image catalog using color. They can do this in at least one of two ways: by keyword or by selecting a color from a list. Users can search for products by entering color names in a text field. Some examples are:

“Red Shoes”

“Red and Black Shoes”

“Dark Crimson Shoes with a hint of Cerulean”

The system is able to parse these query strings and then convert them to a list of color map values that corresponds to the text search. It can potentially handle searching multiple colors simultaneously, color qualifiers (e.g. “light”, “very rich”), misspelled names (“Orannge”), and can even consider secondary colors (“hint of blue”, “dash of red”) in various embodiments.

Not only can consumers search products with these keywords, but a shopping or searching website itself can also use this new type of keyword search to feature products in advertising campaigns, for example. Thus, it can buy keyword ads on a 3rd party search engine that link from the query results for “Red, White and Blue Shoes” to its' own page featuring its' red-white-and-blue shoes for a July 4th promotion.

Alternately, some users may not have a specific color in mind. In this case, the system generates a list of the most-common/well-known colors, sorted by how many results match that general color across the image set. The user may then select a color and refine the search from there, selecting among closely related colors or secondary colors, for example.

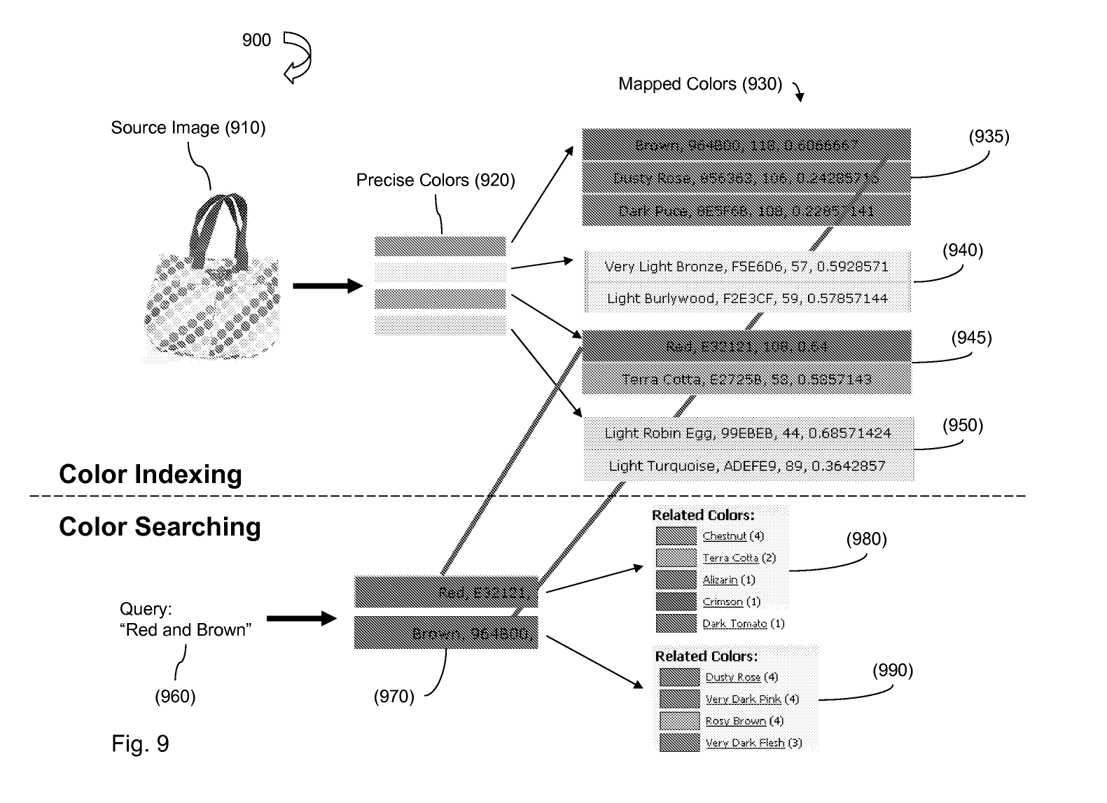

For the example of FIG. 9 in this embodiment, the system found 14 products that have the color black—therefore, that color appears on top. If a user clicks on “Blue”, all blue products will be displayed, including products which may also match to a more specific blue shade (like “Cerulean”). Both the user and marketer can use this information (In the marketer's case, he can choose colors to market for which he knows there are many matches).

In either case (search by keyword or browse by color)—the system can order the results such that the best/closest matches appear first. It uses several criteria to determine the order, including: how closely the precise color matches the discreet color in the color map, the color-match-score (from above—derived from how much of the color appears in the image, the average position, etc), the average click-through-rate for the product (either globally of specific to the searched criteria), as well as how many total colors appear in the image, etc.

In addition, once a color is selected, the system is able to generate a list of “related colors”—colors which closely match the color which was searched on. These are also ordered according to the number of images from the image set which match each specific color. If multiple colors were search upon, multiple “related colors” lists can be displayed at once. In addition, the system can enable users to find “results like this one”. In other words, if a user search on “orange” and found a particular pair of “black and orange” shoes, the system can lookup the colors associated with that image, and then perform a new search using those colors, finding other “black and orange” shoes.

This embodiment and other embodiments may be used in a variety of applications. Retail and internet sales applications represent one possibility. However, one may also search stock photography, satellite images, animal/plant images, microscopic images and telescopic images, for example.

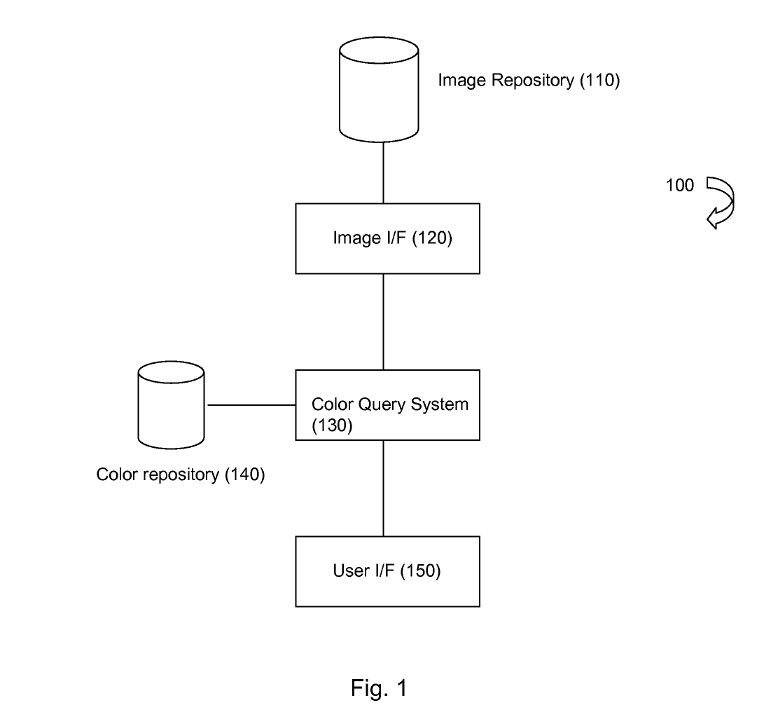

FIG. 1 illustrates an embodiment of a system including color search capabilities. In such an embodiment, the color search system may operate separately from a source of images. Thus, the color search system may interface with a variety of sources of images, such as a variety of sample databases or a variety of store product databases. Illustrated in system 100 is an image repository and front-end, color query system, color data repository and a user interface.

Image repository 110 may be a database of images such as images and descriptions of an online store or images of a database of samples of biological species, for example. Image front-end 120 is a front-end or access point for repository 110, such as a user interface or application program interface (API), for example. Thus, the user interface for Amazon or eBay may represent a front-end for images available from such a website. A front end such as front-end 120 may be a fairly simple query interface or may implement many different functions.

Color query system 130 interfaces with image front-end 120 to access image data, such as through queries or a feed of data, for example. Color query system 130 processes images from image repository 110 and produces or updates color data repository 140. Color data repository 140 includes information about images which can be queried or searched in an effective manner. An embodiment of the data of color data repository 140 is described below. User interface 150 provides a user interface to color query system 130—allowing a user to search based on colors for images and corresponding information. Note that user interface 150 may be implemented as a set of web-pages, a desktop software client, as a server-based user interface, as an API, or in some other manner.

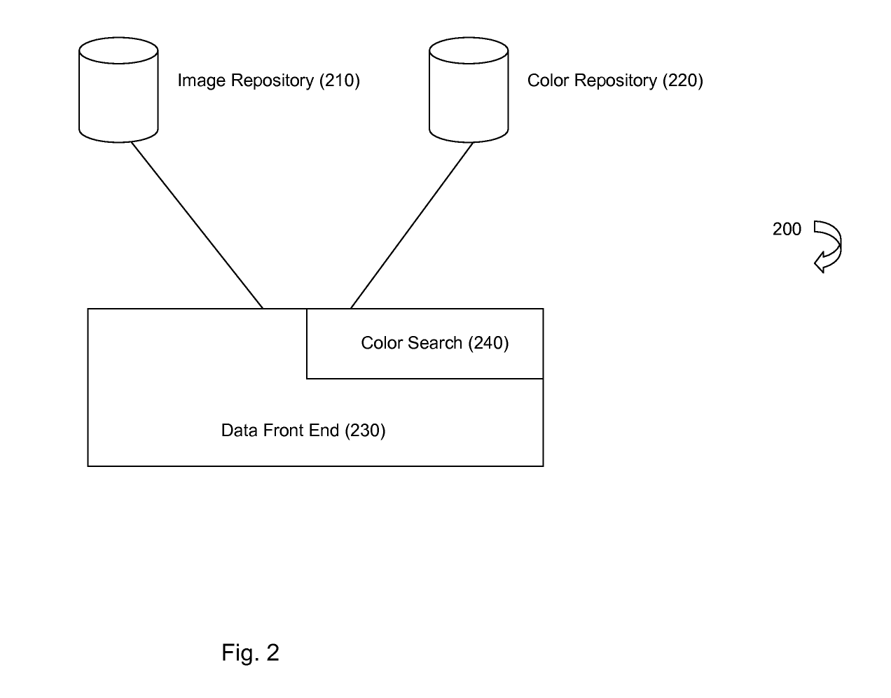

FIG. 2 illustrates another embodiment of a system including color search capabilities. In such an embodiment, the color search system is integrated into a system including an image repository. Illustrated in system 200 is an image repository, a color data repository, a data front end and a color search module. Other components or modules may also be included.

Image repository 210 includes image data and other related data for entries in the repository, such as descriptions, pricing, categorization information and related data. Color repository 220 includes color data related to images in image repository 210—data which classifies the image in a searchable manner. Note that color repository 220 and image repository 210 may be collected in a single physical repository, and the data of the two repositories may be included in a single logical repository—one need not search a separate database for regularized color data when a single database can be implemented, for example.

Data front end 230 is implemented to provide access to image repository 210, such as through user queries or through queries from other software modules, for example. Included therein is color search module 240, which implements color search operations and accesses the data making up color data repository 220. In some embodiments, color search may be a separate subpart of a user interface, for example. In other embodiments, color search may be integrated into a user interface or API, for example.

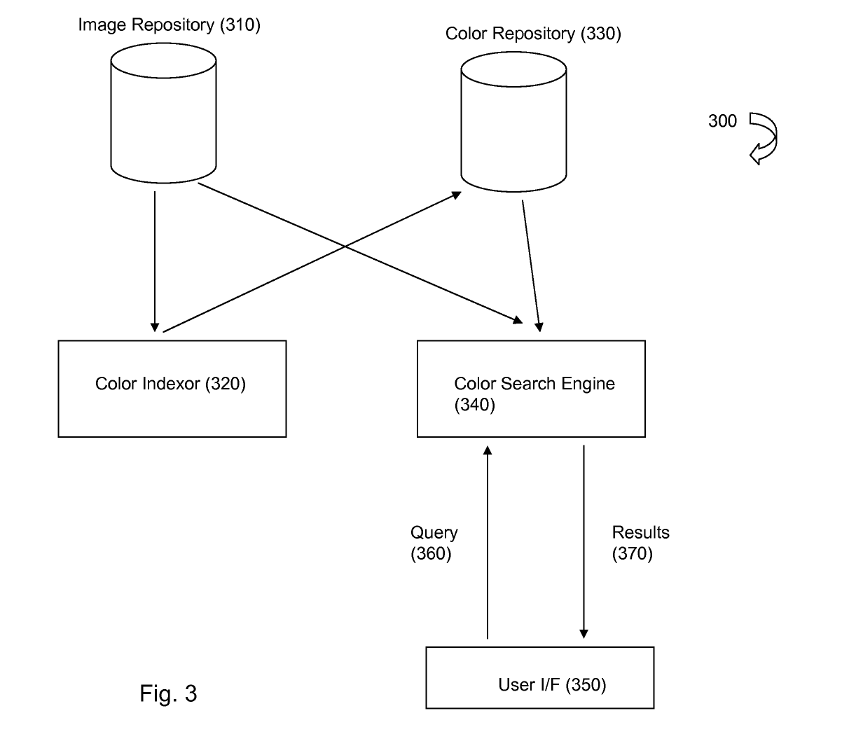

FIG. 3 illustrates an embodiment of a system for implementing color search capabilities. System 300 implements color search capabilities by indexing color data from image data and then searching the color data responsive to queries from a user interface. Such a system may be implemented in a variety of ways to provide similar color search functionality.

Image repository 310 includes image data such as pictures in various formats, and may include other data such as descriptive text, classification or categorization data, and pricing data in commercial applications, for example. Color indexor 320 indexes image data of image repository 310 to produce color data stored in color repository 330. Color data may be regularized or normalized data indicating what colors may be found in an associated image, such as is described further below. Note that image repository 310 and color repository 330 are illustrated as distinct or separate, but may be both logically and physically combined in some embodiments.

Color search engine 340 accesses image data from image repository 310 and color data from color repository 330. In doing so, color search engine 340 may search based on normalized data in color repository 330 for images containing desired colors in image repository 310. Such searches may be performed responsive to a query 360 from user interface 350. The query 360 may specify a color or a color combination at varying levels of specificity (e.g. blue with a red portion or cerulean blue with a light pink spot, for example). Color search engine 340 may then lookup appropriate values related to keywords in the query 360, and search for color data close to those values in color repository 330. With matches from color repository 330, associated images may be retrieved from image repository 310 and provided as part of a result 370 to user interface 350.

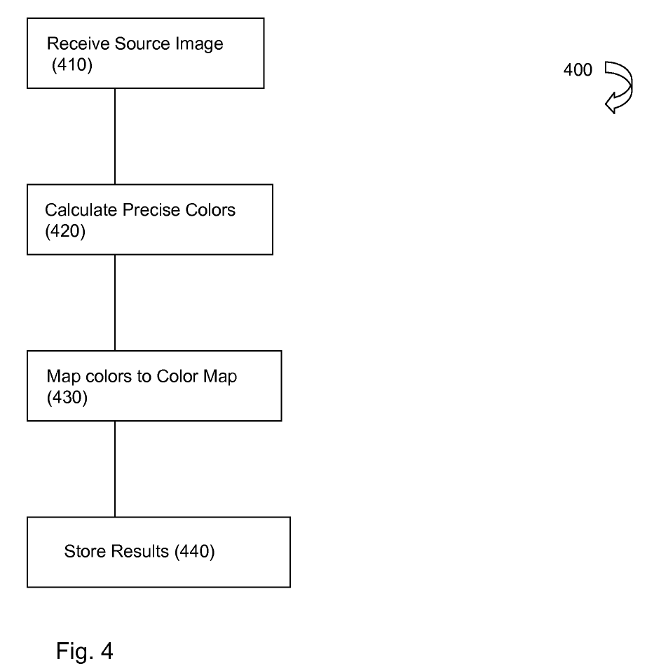

FIG. 4 illustrates an embodiment of a process of collecting color data from images. For a given source image, color data may be retrieved and then translated into a normalized set of colors. Process 400 includes receiving a source image, cataloging precise colors of the image, mapping the colors to a color map and storing the results. Process 400 and other processes of this document are implemented as a set of modules, which may be process modules or operations, software modules with associated functions or effects, hardware modules designed to fulfill the process operations, or some combination of the various types of modules, for example. The modules of process 400 and other processes described herein may be rearranged, such as in a parallel or serial fashion, and may be reordered, combined, or subdivided in various embodiments.

Process 400 initiates with receipt of an image at module 410. Precise colors within the source image are cataloged or inventoried at module 420—a list of color values of the image is created, along with a score related to the frequency of appearance and average position of each color. This list may then be mapped to colors of a color map at module 430, based on a distance algorithm, for example. This list may also be truncated, based on a minimum value for frequency of occurrence, for example. Moreover, the mapping process may include removing colors identified as skin tones of models or background colors, for example. With the results finalized, the data is stored at module 440, such as in a color data repository.

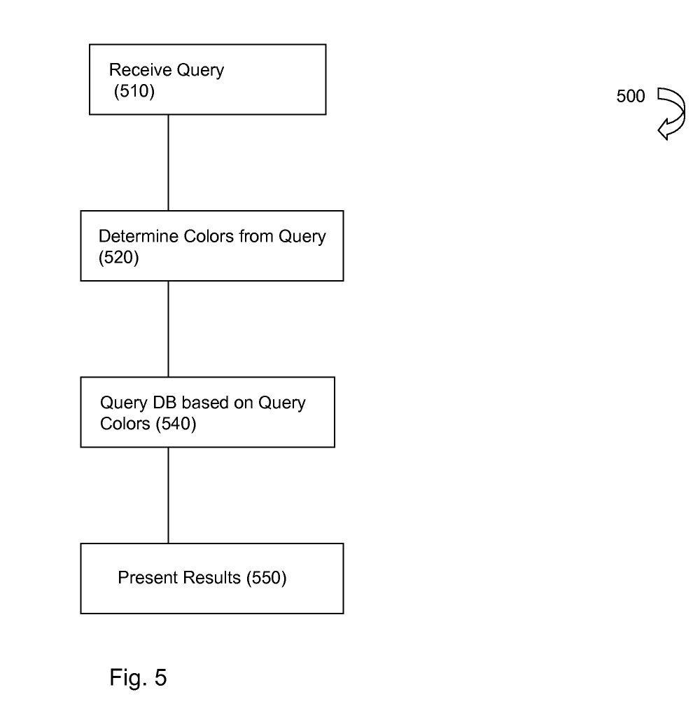

FIG. 5 illustrates an embodiment of a process of searching color data. Process 500 includes receiving a query, parsing colors from the query, mapping the parsed colors to a color map, querying a database based on the color map values, and presenting results from the database. Thus, process 500 may search the data created or extracted in process 400, and ultimately retrieve images processed in process 400.

At module 510, a query is received, in natural language or as keywords or by clicking on a color in a color list. This query includes colors desired by a user. The colors are parsed from the query at module 520, with parsing potentially including identifying misspellings or equivalent colors, for example. At module 530, the parsed colors are mapped to a color map, providing corresponding values for the colors in question. A database of color data is queried at module 540 based on the color values of module 530—with the normalized values allowing for relatively straightforward queries and for implementation of a sorting algorithm, for example. Results of the query of module 540 are presented at module 550. Note that in some embodiments, a function may be included to allow an operator to edit out unreasonable results, either in the data collection process or as part of the query process.

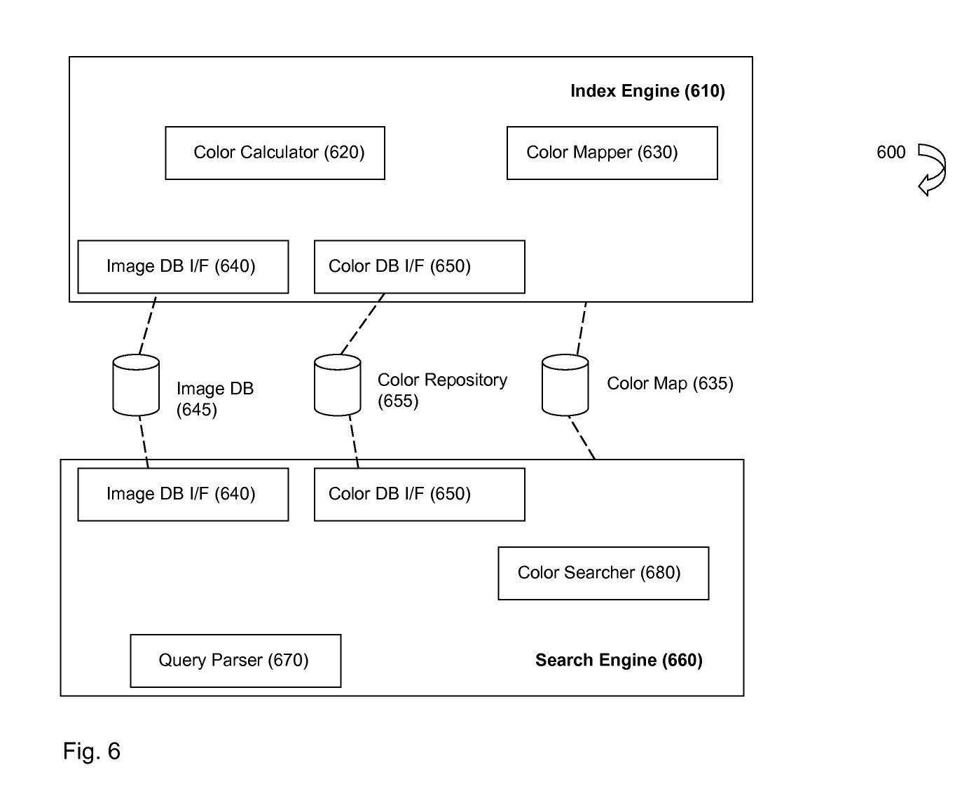

FIG. 6 illustrates an embodiment of machine-readable media which embody a system for collecting and searching color data. Medium 600 may include multiple media of one or more types which embody modules used to implement a system or method. As illustrated, index engine 610 and search engine 660 are embodied, with the expectation that both engines 610 and 660 would interact with repositories 645 and 655 and data structure 635.

Index engine 610 includes color inventory module 620, color match module 630, image database interface 640 and color database interface 650. Inventory module 620 may find color values in an image obtained through image database interface 640 from an image database 645. Color match module 630 may then match color values to values of a color map 635, normalizing color values into a predictable universe of color values. The normalized color values may then be stored in a color database 655 accessed through color database interface 650.

Search engine 660 may be used to find color data, using a query parse module, a color mapping module, a results generation module, and image and color database interface modules. Query parse module 670 may parse a query from words into identifiable colors, which may then be mapped by color mapping module 680 to values of color map 635. A query may then be sent through color database interface 650 based on the color values, resulting in information about matching images. Matching images may then be retrieved through image database interface 640. These matching images may then be sorted or ordered with a results generator module 690—allowing for results ordered based on color matches, popularity (click-through rates, e.g.) or other criteria.

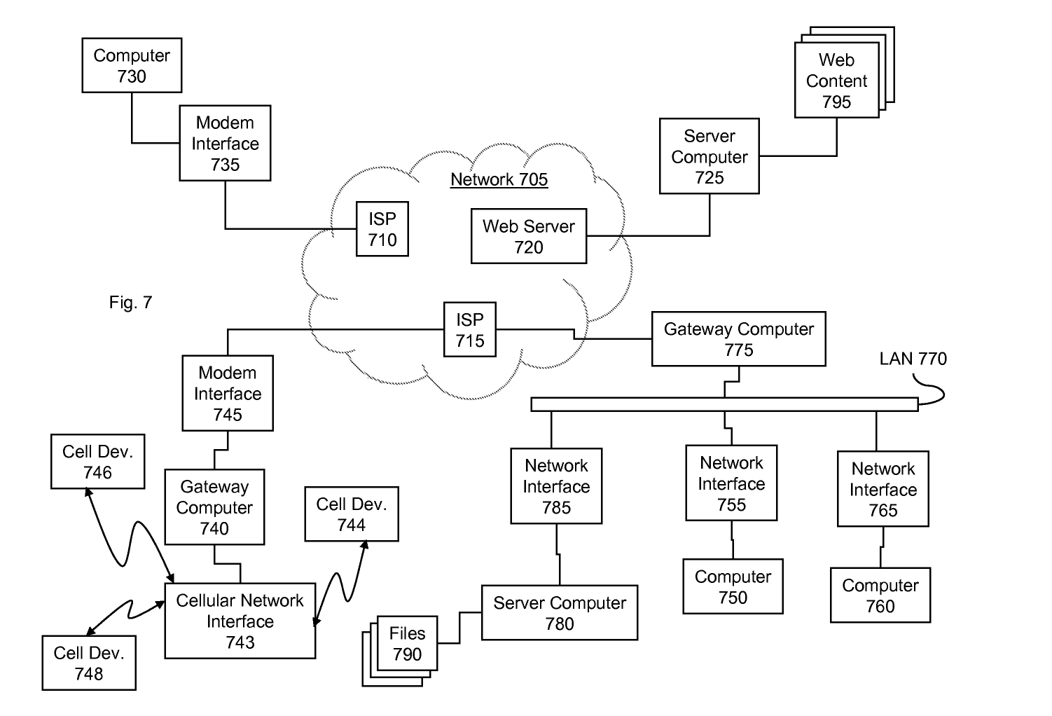

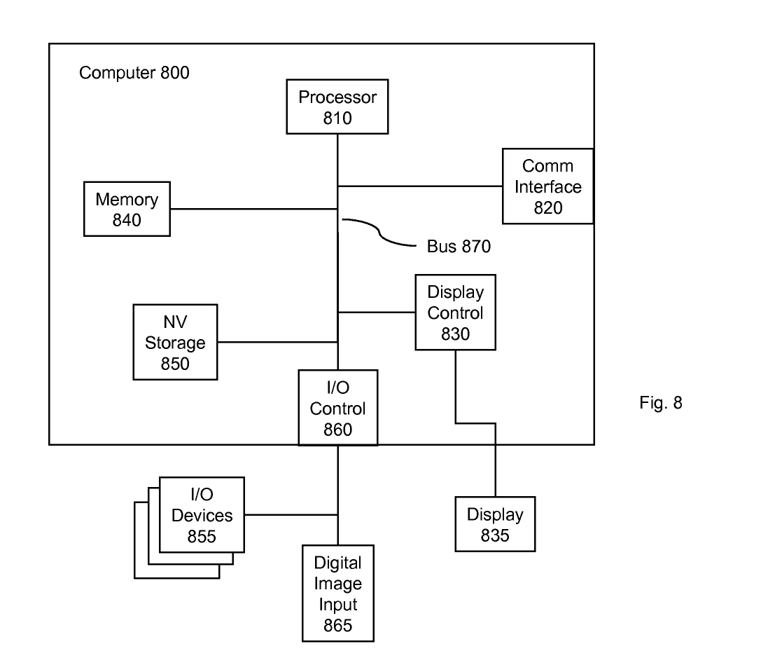

FIG. 7 illustrates an embodiment of a network of systems which may be used in conjunction with color search systems and processes. FIG. 8 illustrates an embodiment of a computer or similar machine which may be used in the network of FIG. 7 and may also be used to implement a color search system or process. The following description of FIGS. 7-8 is intended to provide an overview of device hardware and other operating components suitable for performing the methods of the invention described above and hereafter, but is not intended to limit the applicable environments. Similarly, the hardware and other operating components may be suitable as part of the apparatuses described above. The invention can be practiced with other system configurations, including personal computers, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the internet, along with a cellular or other wireless network and related cellular or other wireless devices. The term “internet” as used herein refers to a network of networks which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 705 is typically provided by internet service providers (ISP), such as the ISPs 710 and 715. Users on client systems, such as client computer systems 730, 750, and 760 obtain access to the internet through the internet service providers, such as ISPs 710 and 715. Access to the internet allows users of the client computer systems to exchange information, receive and send e-mails, and view documents, such as documents which have been prepared in the HTML format. These documents are often provided by web servers, such as web server 720 which is considered to be “on” the internet. Often these web servers are provided by the ISPs, such as ISP 710, although a computer system can be set up and connected to the internet without that system also being an ISP.

The web server 720 is typically at least one computer system which operates as a server computer system and is configured to operate with the protocols of the world wide web and is coupled to the internet. Optionally, the web server 720 can be part of an ISP which provides access to the internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Cellular network interface 743 provides an interface between a cellular network and corresponding cellular devices 744, 746 and 748 on one side, and network 705 on the other side. Thus cellular devices 744, 746 and 748, which may be personal devices including cellular telephones, two-way pagers, personal digital assistants or other similar devices, may connect with network 705 and exchange information such as email, content, or HTTP-formatted data, for example.

Cellular network interface 743 is representative of wireless networking in general. In various embodiments, such an interface may also be implemented as a wireless interface such as a Bluetooth interface, IEEE 802.11 interface, or some other form of wireless network. Similarly, devices such as devices 744, 746 and 748 may be implemented to communicate via the Bluetooth or 802.11 protocols, for example. Other dedicated wireless networks may also be implemented in a similar fashion.

Cellular network interface 743 is coupled to computer 740, which communicates with network 705 through modem interface 745. Computer 740 may be a personal computer, server computer or the like, and serves as a gateway. Thus, computer 740 may be similar to client computers 750 and 760 or to gateway computer 775, for example. Software or content may then be uploaded or downloaded through the connection provided by interface 743, computer 740 and modem 745.

Client computer systems 730, 750, and 760 can each, with the appropriate web browsing software, view HTML pages provided by the web server 720. The ISP 710 provides internet connectivity to the client computer system 730 through the modem interface 735 which can be considered part of the client computer system 730. The client computer system can be a personal computer system, a network computer, a web tv system, or other such computer system.

Similarly, the ISP 715 provides internet connectivity for client systems 750 and 760, although as shown in FIG. 7, the connections are not the same as for more directly connected computer systems. Client computer systems 750 and 760 are part of a LAN coupled through a gateway computer 775. While FIG. 7 shows the interfaces 735 and 745 as generically as a “modem,” each of these interfaces can be an analog modem, isdn modem, cable modem, satellite transmission interface (e.g. “direct PC”), or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other internet related services for the local area network. This gateway computer system 775 is coupled to the ISP 715 to provide internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the internet through the gateway system 775.

FIG. 8 shows one example of a personal device that can be used as a cellular telephone (744, 746 or 748) or similar personal device, or may be used as a more conventional personal computer, as an embedded processor or local console, or as a PDA, for example. Such a device can be used to perform many functions depending on implementation, such as monitoring functions, user interface functions, telephone communications, two-way pager communications, personal organizing, or similar functions. The system 800 of FIG. 8 may also be used to implement other devices such as a personal computer, network computer, or other similar systems. The computer system 800 interfaces to external systems through the communications interface 820. In a cellular telephone, this interface is typically a radio interface for communication with a cellular network, and may also include some form of cabled interface for use with an immediately available personal computer. In a two-way pager, the communications interface 820 is typically a radio interface for communication with a data transmission network, but may similarly include a cabled or cradled interface as well. In a personal digital assistant, communications interface 820 typically includes a cradled or cabled interface, and may also include some form of radio interface such as a Bluetooth or 802.11 interface, or a cellular radio interface for example.

The computer system 800 includes a processor 810, which can be a conventional microprocessor such as an Intel pentium microprocessor or Motorola power PC microprocessor, a Texas Instruments digital signal processor, or some combination of the various types or processors. Memory 840 is coupled to the processor 810 by a bus 870. Memory 840 can be dynamic random access memory (dram) and can also include static ram (sram), or may include FLASH EEPROM, too. The bus 870 couples the processor 810 to the memory 840, also to non-volatile storage 850, to display controller 830, and to the input/output (I/O) controller 860. Note that the display controller 830 and I/O controller 860 may be integrated together, and the display may also provide input.

The display controller 830 controls in the conventional manner a display on a display device 835 which typically is a liquid crystal display (LCD) or similar flat-panel, small form factor display. The input/output devices 855 can include a keyboard, or stylus and touch-screen, and may sometimes be extended to include disk drives, printers, a scanner, and other input and output devices, including a mouse or other pointing device. The display controller 830 and the I/O controller 860 can be implemented with conventional well known technology. A digital image input device 865 can be a digital camera which is coupled to an I/O controller 860 in order to allow images from the digital camera to be input into the device 800.

The non-volatile storage 850 is often a FLASH memory or read-only memory, or some combination of the two. A magnetic hard disk, an optical disk, or another form of storage for large amounts of data may also be used in some embodiments, though the form factors for such devices typically preclude installation as a permanent component of the device 800. Rather, a mass storage device on another computer is typically used in conjunction with the more limited storage of the device 800. Some of this data is often written, by a direct memory access process, into memory 840 during execution of software in the device 800. One of skill in the art will immediately recognize that the terms “machine-readable medium” or “computer-readable medium” includes any type of storage device that is accessible by the processor 810 and also encompasses a carrier wave that encodes a data signal.

The device 800 is one example of many possible devices which have different architectures. For example, devices based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

In addition, the device 800 is controlled by operating system software which includes a file management system, such as a disk operating system, which is part of the operating system software. One example of an operating system software with its associated file management system software is the family of operating systems known as Windows CE® and Windows® from Microsoft Corporation of Redmond, Wash., and their associated file management systems. Another example of an operating system software with its associated file management system software is the Palm® operating system and its associated file management system. The file management system is typically stored in the non-volatile storage 850 and causes the processor 810 to execute the various acts required by the operating system to input and output data and to store data in memory, including storing files on the non-volatile storage 850. Other operating systems may be provided by makers of devices, and those operating systems typically will have device-specific features which are not part of similar operating systems on similar devices. Similarly, WinCE® or Palm® operating systems may be adapted to specific devices for specific device capabilities.

Device 800 may be integrated onto a single chip or set of chips in some embodiments, and typically is fitted into a small form factor for use as a personal device. Thus, it is not uncommon for a processor, bus, onboard memory, and display/I-O controllers to all be integrated onto a single chip. Alternatively, functions may be split into several chips with point-to-point interconnection, causing the bus to be logically apparent but not physically obvious from inspection of either the actual device or related schematics.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

Data collection and searching for data are typically related in a system—the searches must yield reasonably predictable results to be useful. FIG. 9 illustrates results of color data collection and searching in some embodiments. Illustration 900 includes a source image, cataloged colors and mapped colors, and also includes a query, parsed colors and mapped colors. Thus, source image 910 is cataloged to include a set of precise colors 920 (color values). These color values of the precise colors 920 are mapped to normalized colors 930 of a color map, including colors in a brown group 935, light brown group 940, red group 945 and light blue group 950.

Such colors may then be searched. A query 960 includes a request for red and brown colors. This is parsed and mapped to mapped (normalized) colors 970, which correspond to related colors in normalized colors 930. Groups of related colors are also looked up for each normalized color 970, thereby finding red group 990 and brown group 980 from a lookup table, for example. Searches can then be run based on the groups 980 and 990 and the normalized colors 970, with results ranked based on a distance algorithm, for example.

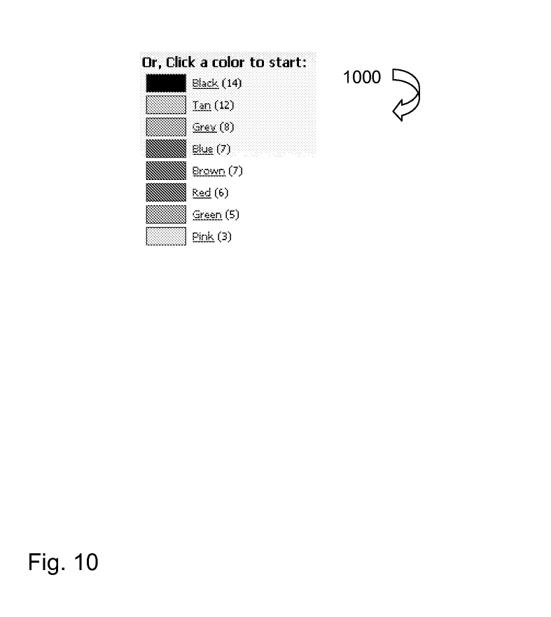

In some embodiments, a user browses among colors by selecting colors. FIG. 10 illustrates a set of colors for browsing in some embodiments. Window 1000 provides a list of colors with blocks of the color and an indication of how many images show a given color. Thus, a user may click one of the colors to narrow the range of images available.

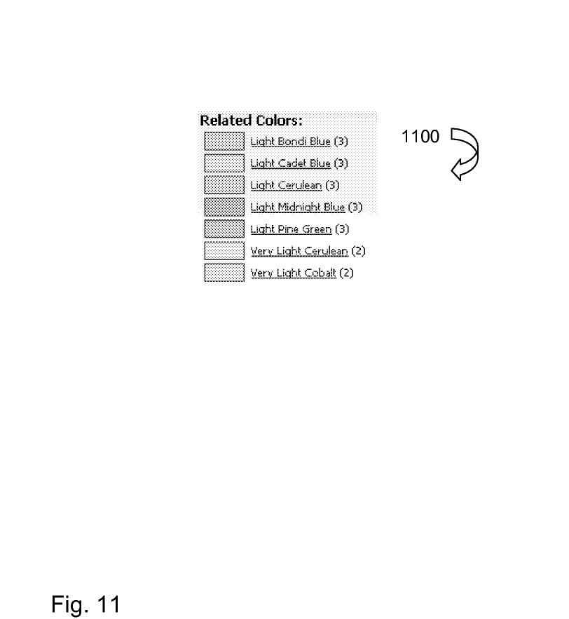

With a color chosen (such as blue, for example), another set of (related) colors may be provided to further narrow a range of images or to provide a means to view similarly colored images. FIG. 11 illustrates another set of colors for browsing in some embodiments. Window 1100 displays another set of colors with color blocks and quantities of images including those colors. These colors may all be closely related—within a broad classification in a color map for example.

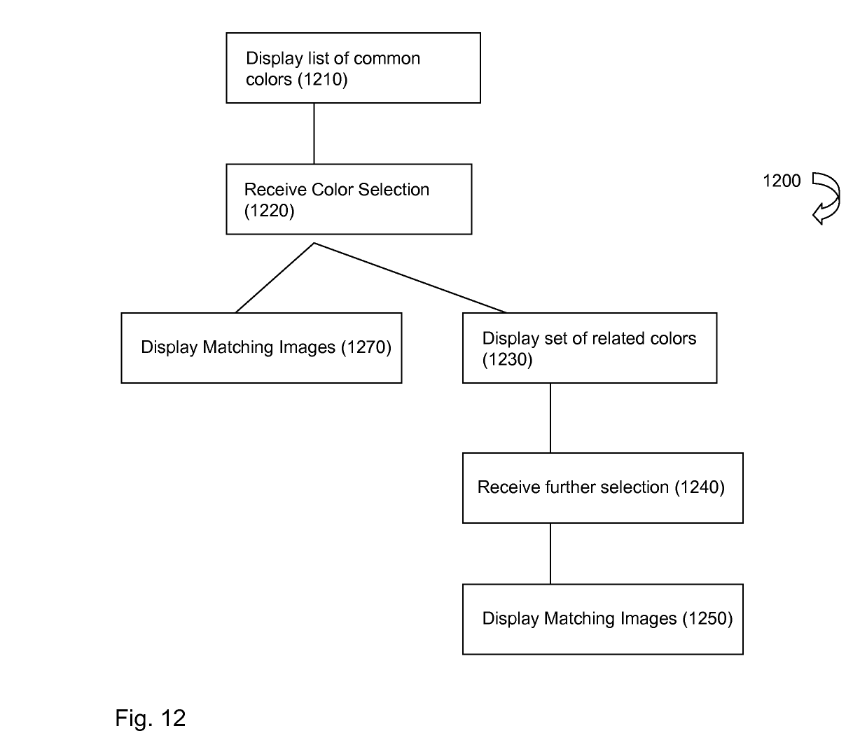

A more general approach to a process involving FIGS. 10 and 11 may be implemented. FIG. 12 illustrates an embodiment of a process of searching for an image. Process 1200 includes displaying a set of colors, receiving a color selection, displaying a set of precise colors (related to the color selection), receiving a further selection, and displaying resulting images.

Process 1200 initiates at module 1210 with display of a general set of colors. One of the colors is chosen at module 1220. Based on the chosen color, a set of precise colors related to the chosen color are displayed at module 1230. A further selection of one of the precise colors is then received at module 1240. In some systems, more levels of revision may be implemented, either to further refine choices within a general color range, or to evaluate secondary colors included in an image, for example. At module 1250, available images are displayed based on the selections made.

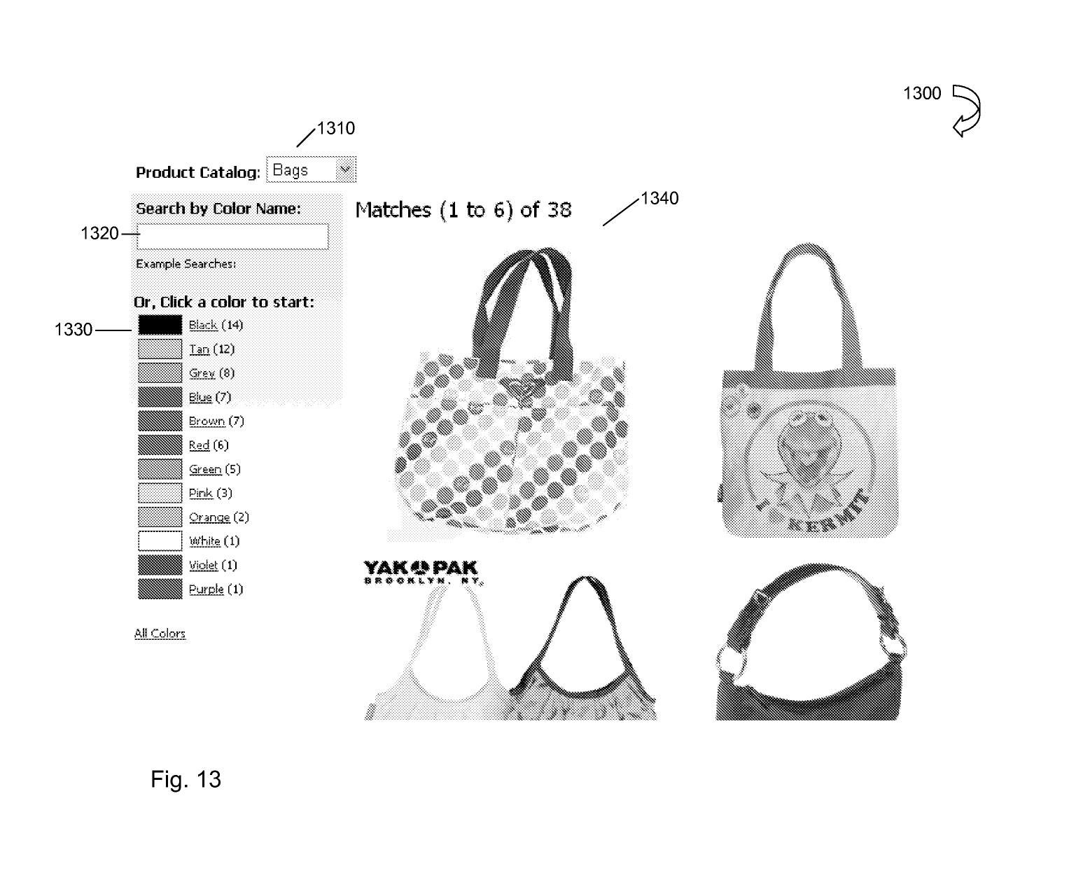

A user interface may involve various different approaches to searching by color, including browsing images, browsing colors, or entering a query. FIG. 13 illustrates an embodiment of a user interface displaying images in a color search system. Interface 1300 incorporates several options for searching images. Drop-down menu 1310 provides a selection of types or catalogs of images. Query box 1320 allows for entry of keywords or natural language queries for searching. Color window 1330 allows for selection of a color from a palette or list of colors. Results display 1340 provides results of a search or query (or selection of a color).

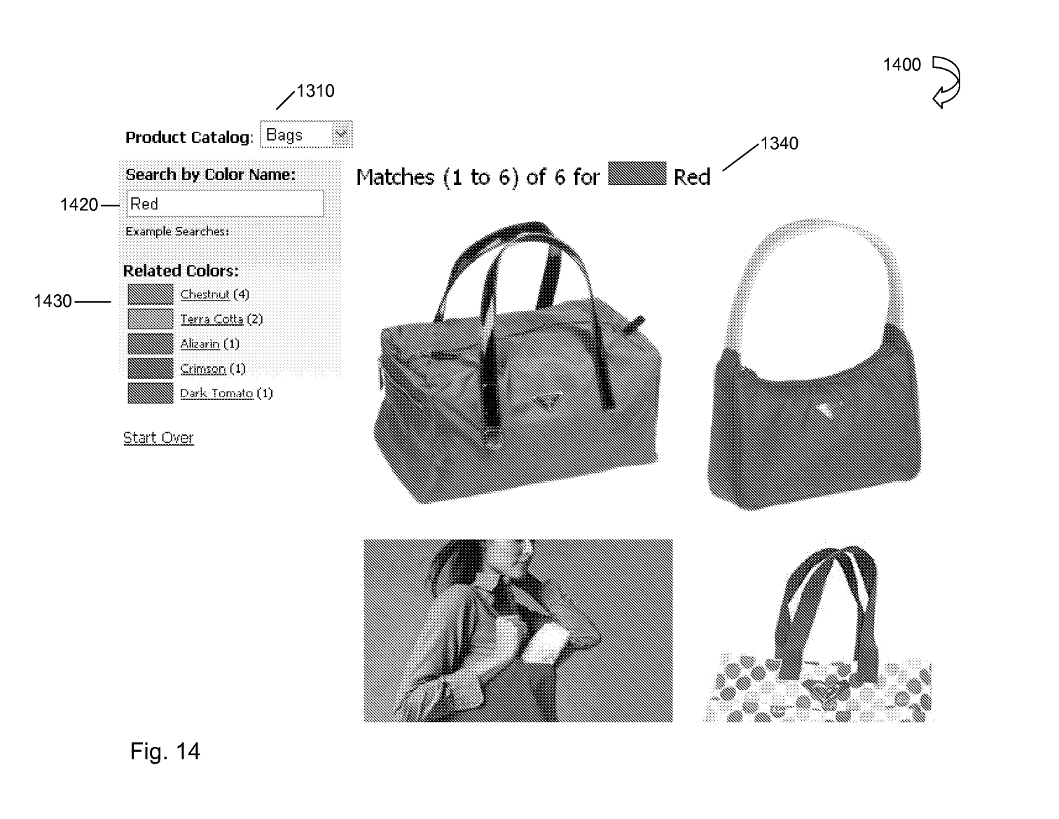

FIG. 14 illustrates the embodiment of FIG. 13 after a refined search. With red chosen as a query entry 1420, a set of related colors (palette) is provided in color display 1430. Similarly, results display 1340 is updated.

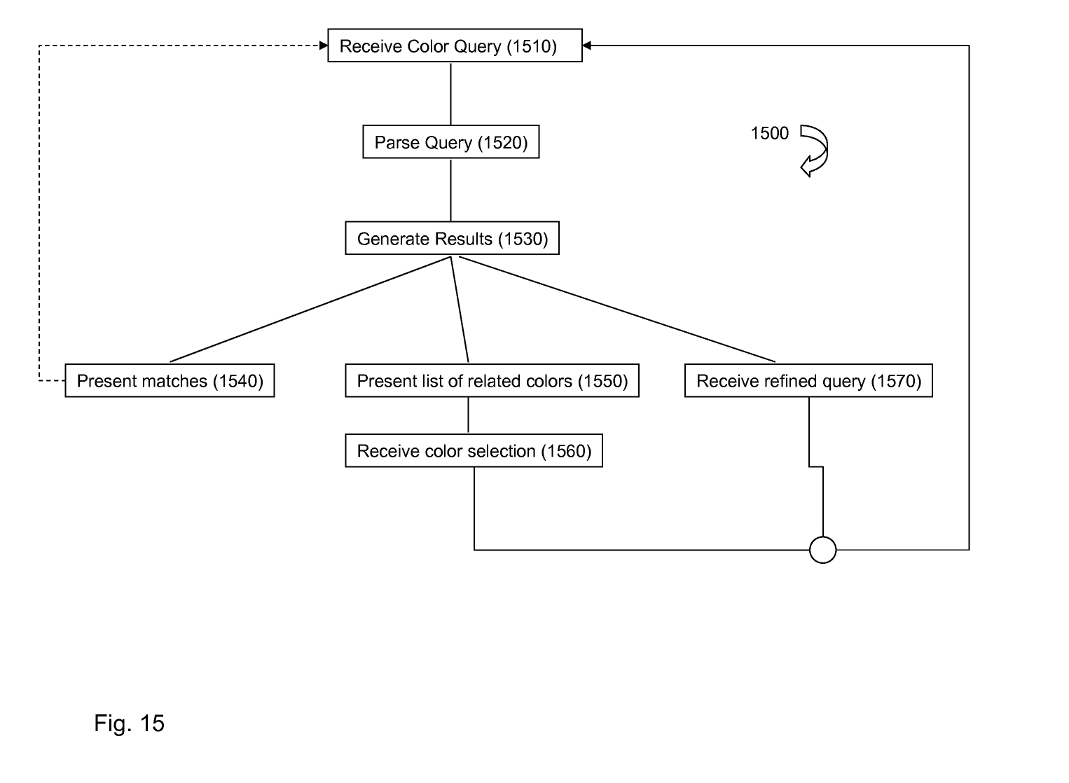

Thus, a refined image search process may be implemented. FIG. 15 illustrates another embodiment of a process of searching for an image. Process 1500 includes receiving a color query, parsing the query, generating results, presenting images, presenting precise related colors, receiving either a precise color selection or a refined query, and repeating the process.

Process 1500 initiates with receipt of a color query or selection at module 1510. At module 1520, the query or selection is parsed. Results are generated (searched for and found) based on the initial query at module 1525. In parallel, results are presented, precise colors are presented, and a selection or query is received.

Thus, results are presented at module 1540, based on whatever images matched the present query or selection. At module 1530, precise color results related to the present query are presented—this may involve refinement of a color of the query or selection, or related colors of images. The query may be refined at module 1550, or a precise color selection may be received at module 1570. The process may then repeat with the new query or selection received at module 1510.

The various embodiments described above may be used in a variety of commercial settings. For example, one may interface the search system with a third-party website to provide a different access point for that third-party website through which color searching may be implemented. This would potentially be a wholly separate website or a related website. Alternatively, color searching may be integrated into a website, to the point that color search data may be incorporated into a repository of images, for example.

In some instances, color search data may be used to determine what images are displayed together, allowing a website working with fashion-related items to display items likely to match rather than clash, for example. Thus, a color search engine may be used based on one image to find images with similar colors. In other instances, a search result may be created and made available through a special URL. Either the URL may encode a search query, thus causing the search to be executed based on a predetermined query, or the URL may point to a stored result of a search. In either instance, such a URL may be linked to a banner advertisement or similar internet related advertisement. Likewise, it may be embedded in an email or other form of electronic message. Note that URLs which encode search queries may use natural language encoding or discreet color values (for example). In either case, the URL may pass parameters as is often done with URLs.

Monetization of this system and process may occur in a variety of ways. This may include basic licensing of the system or partnering with websites and other entities using the system. It may also involve a per-use form of fee for websites offering the system and its results, either over the web or at some other facility such as an in-store kiosk, for example. Advertising may also be coordinated based on common colors, allowing for choices of different colored advertisements based on what colors are (or are not) displayed on a webpage, for example.

A reference implementation of one embodiment is described below. This implementation includes numerous specific details important to the particular embodiment, which may be implemented in different ways in other embodiments. Moreover, features of this embodiment may be combined or subdivided in other embodiments, such as embodiments described elsewhere. Also, features of other embodiments may be incorporated into variations of this embodiment, and this embodiment may be implemented in various ways without some of the features discussed below.

First, some basic functions/definitions that are used throughout the system in this embodiment are described.

Average:

```
    The average of a color's 3 component colors:
      Average (Color) = (red + green + blue)/3
  isBlack
      Whether color should be considered black.
    Avg = Average(Color)
    isBlack (Color) = Average(Color) + abs(red−avg) + abs(green−avg) +
abs (blue − avg) < BlackThreshold
  isWhite
      Whether color should be considered white.
    Avg = Average(Color)
    isWhite(Color) = (avg> WhiteAvgThreadhold) AND (abs(red−avg) +
abs(green−avg) + abs (blue − avg)) < WhiteDiffThreshold
  isGrey
      Whether a color should be considered greyscale
    Avg = Average(Color)
    GreyRadius( Avg ) = Greyscale cutoff given an average. Can be
implemented via a lookup table based on the avg (e.g. if avg<60,
return(50), else if avg<100, return(40)) - or can be based on a
more specific function based on the avg.
    isGrey(Color) = abs(red−avg) + abs(green−avg) + abs (blue − avg)) <
GreyRadius( avg);
  Distance:
    The spherical distance between 2 colors (in 3 dimensions: red, green,
blue).
  Distance (Color1, Color2) = sqrt( (red1−red2)\hat{ }2 + (green1−green2)\hat{ }2 +
(blue1−blue2)\hat{ }2)
  DistanceMatch:
    2 colors match based on distance
    Radius( Color1, Color2 ) = Radius cutoff given to Colors. Can be
implemented via a lookup table based on the averages of the 2 colors
averages ( Average(Color1) + Average(Color2) / 2) (e.g. if avg<60,
return(50), else if avg<100, return(40)) - or can be based on a more
specific function based on the Average average.
    DistanceMatch(Color1, Color2) = Distance (Color1, Color2) <
Radius(Color1, Color2)
  SimpleDistance:
  SimpleDistance (Color1, Color2) = abs (red1−red2) +
abs(green1−green2) + abs(blue1−blue2)
  ShadeMatch:
    Colors can be separated by a significant distance, but still “look” the
same, since they are just a different shade of the same color.
    MaxAverage(Color1, Color2) = Max( Average(Color1),
Average(Color2))
    ShadeRadius (Color1, Color2) = a function based on
MaxAverage(Color1, Color2) - like GreyRadius, it can be a simple
lookup table, or a more complex function based on the max.
    ColorPrime = Color( red − avg, green−avg, blue−avg)
    LightColorsOnly (Color1, Color2) =
      + if ( (red1 > LightThreashold) and (red2 > LightThreashold))
        abs(red1 − red2)
      + if ( (green1 > LightThreashold) and (green2 > LightThreashold))
        abs(green1 − green2)
      + if ( (blue1 > LightThreashold) and (blue2 > LightThreashold))
        abs(blue1 − blue2)
    ShadeMatch(Color1, Color2)=
      Abs(Average(Color1) − Average(Color2)) < AverageThreadhold
AND
      isGrey(Color1) = isGrey(Color2) AND
      (
      Distance ( ColorPrime(Color1), ColorPrime(Color2)) <
ShadeRadius (Color1, Color2) OR
        LightColorsOnly (Color1, Color2) < TotalLighThreshhold
      )
```

IsFleshColorLikelihood

This takes a color and returns the likelihood (on a scale from 0-1) that this color represents a flesh color. It is based on a complex set of comparisons between the relative component colors. Here are the details of one implementation:

| | |
|---|---|
| int avg = (red + green + blue)/3; | |
| if(isGreyscale(red, green, blue, avg)) | return(0F); |
| if(avg < 60) | return(0F); |
| if(avg > 240) | return(0F); |
| if(red<90 && green<90 && blue<90) | return(0F); |
| int red_value = red − green; | |
| if(red_value < 7 \|\| red_value>110) | return(0F); |
| int blue_value = blue − green; | |
| if(blue_value < −70 \|\| blue_value > 7) | return(0F); |
| int sum = red_value + blue_value; | |
| if(sum < −35 \|\| sum > 88 \|\| | |

```
            (sum > 70 && avg < 130 && blue_value > −5) ||
            (sum < −10 && avg > 190 && red_value < 20))
```

return(0F);

```
        float likelihood = 1.0F;
        float red_share = 0.3F;
        float blue_share = 0.3F;
        float brightness_share = 0.4F;
```

| | |
|---|---|
| if(red_value < 30) | likelihood−= (1.0F − |

(((float)red_value − 7.0F) / 23.0F)) * red_share;

| | |
|---|---|
| else if(red_value > 60) | likelihood−= (1.0F − ((110F |

− (float)red_value) / 50.0F)) * red_share;

| | |
|---|---|
| if(blue_value < −30) | likelihood−= (1.0F − |

(((float)blue_value − (−70.0F)) / 40.0F)) * blue_share;

| | |
|---|---|
| else if(blue_value > −10) | likelihood−= (1.0F − ((7 − |

(float)blue_value) / 17.0F)) * blue_share;

| | |
|---|---|
| if(avg < 130) | likelihood−= (1.0F − |

(((float)avg − 60.0F) / 70.0F)) * brightness_share;

| | |
|---|---|
| else if(avg > 190) | likelihood−= (1.0F − ((240F |

− (float)avg) / 50.0F)) * brightness_share;
return(likelihood);

Color Indexing

First, a 2-dimensional array holding the color values for each pixel is created. The first operation is to pre-process the image, to look for (A) Solid Borders, and (B) Gradient Backgrounds. These are both potentially helpful in figuring out which colors are “background colors”.

Solid Borders:

The system considers each edge (top, bottom, left, right) of the image separately. For each edge, it takes several samples. For each sample, it starts at the edge and works towards the inside of the image. It compares each pixel to the next pixel—if any of the following are true:

Distance(Color1, Color2)>MaxDistanceThreashold OR

ShadeMatch(Color1, Color2)=FALSE OR

isWhite(Color1)!=isWhite(Color2) OR

isBlack(Color1)!=isBlack(Color2) OR

isGrey(Color1)!=isGrey (Color2)

It marks the distance from the edge of the image as the “breakpoint” and then moves onto the next sample. If it finds no breakpoint by the time it gets to the halfway point across the image, it ignores that sample and moves on.

For each edge, it now has a set of distance samples. If it has enough samples per edge, it throws out the high and low samples, and then calculates the standard deviation of the remainder. If the standard deviation is below a threshold value, it considers that edge to have a solid (straight-line) border. It combines these 4 borders into a Clip-Rectangle: A rectangle which excludes any solid borders.

Gradient Backgrounds

The goal of this procedure is to filter out a gradient (i.e. shaded) background by calculating a polygon which roughly includes the primary object but excludes a shaded but otherwise uniformly colored background. It works by taking several samples along the left and right edges of the image, working inward (similar to above). It compares the SimpleDistance of each pixel's color to the next, and stops when that distance is greater then a threshold. (If it gets to the center line, it ignores that sample.)

At this point, it now has a set of several points for each edge (left and right). For each edge, it connects the dots to form a jagged line. For each jagged line, it counts the number of “direction changes”—i.e. when the line switches from moving left-to-right to right-to-left, or vice-versa. If the number of direction changes per line is less then a specific threshold (generally the case with a well defined object), and the number of samples per line is greater then a threshold, it connects the 2 lines to form a polygon. Otherwise, it returns NULL if it didn't find a polygon.

Processing Pixels into ColorGroups:

At this point, the system now has enough information to start processing the pixels. For each pixel within the Solid Border's Clip-Rectangle, it tries to find an existing matching ColorGroup. A ColorGroup is a collection of similarly colored pixels. A color matches a ColorGroup if the DistanceMatch (the color, the average of all pixels within the group)=true. If it matches no existing ColorGroups, the process creates a new ColorGroup, using the pixel as the initial value.

Every time a pixel is added to a ColorGroup, it also adds delta scores to the group. These include:

PositionDelta (the likelihood that a pixel is the background based on its position in the image—both whether it is in the gradient polygon, and the distance from the center of the image). This is a value between −1 and 1. It is defined as:

| total = 0F; | |
|---|---|
| if(poly!=null) { | |
| boolean in_poly = poly.contains(x, y); | |
| if(!in_poly) | return(−0.8F); |
| else | total+=0.2F; |
| } | |

total+= min( (x), (width−x) ) / (width/2) − 0.5F;
total+= min( (y), (height−y) ) / (height/2) − 0.5F;
return(total);

Where poly is the gradient polygon calculate from above, and x, y, width, height are all relative to the Solid Border's clip-rectangle, if it exists.

VerticalDelta (Whether the pixel is more vertically orientated or horizontally orientated). Defined as:

half_width=width/2;

horizontal=(half_width−min(x, width-x))/half_width;

half_height=height/2;

vertical=(half_height−min(y, height-y))/half_height

return(vertical−horizontal);

Merging ColorGroups

Once it has processed all the pixels, the next operation is to merge ColorGroups. Some ColorGroups are so similar that they effectively represent the same color. The system compare all ColorGroups to each other, and merge 2 groups (ColorGroupA and ColorGroupB) if

The average color of each group are a DistanceMatch (where the radius is from ColorGroupA, but is increased by a set multiple).

Or, the average color of each group are a ShadeMatch

When 2 ColorGroups are matched, their average, total position, total vertical score, etc. are all merged. Each merged group is also compared to the other groups, so, in this manner, the system may significantly reduce the total number of groups.

Scoring ColorGroups

At this point, the system can now score each color group. The score for each color group is

position_ratio*my_count_share*multiplier

Where:

position_ratio=total position score (from all pixels)/number of pixels

my_count_share=number of pixels in my group/total number of pixels in all groups

multiplier=an adjustment multiplier designed to penalize flesh colors, black colors (which can often result from too many shadows), greyscale colors (especially vertically orientated greyscale, which often comes from mannequins), and low-variance colors (little variance in the colors in the ColorGroup—often due to being a background color). Many of these are relevant to the vertical ratio (humans and mannequins normally appear vertical in photos). The full calculation is listed here:

```
  multiplier = 1.0F;
  flesh = isFleshLikelihood( );
  if((flesh > 0.4F && vertical_ratio>0F) || flesh > 0.7F) {
    flesh_factor = 1.0F − flesh;
    if(flesh_factor>1.0F) flesh_factor = 1.0F;
    multiplier = (float)(Math.pow(flesh_factor,
    nocolormode?0.5F:2.2F));
    if(vertical_ratio > 0.18F) { // most vertical, penalize
      multiplier *= 0.30F;
    }
    else if(vertical_ratio > 0.05F){ // more vertical, penalize
      multiplier *= 0.60F;
    }
    else if(vertical_ratio < −0.10F) { // more horizontal, reward
      multiplier *= 1.6F;
    }
  }
  else if(my_count_share < 0.50F && position_ratio < 0.75F) {
    if(isBlack( )) {
      multiplier = 0.5F;
      if(vertical_ratio > 0.20F)  { // more vertical, penalize (happens a
lot with black hair)
      multiplier *= 0.60F;
      }
    }
    else if(isGreyscale( )) {
      multiplier = 0.4F;
      if(position_ratio < 0.20F) { // bad position, penalize (happens a
lot with background greys)
      multiplier *= 0.60F;
      }
    }
    if(isBlack( ) || isGreyscale( )) {
      if(vertical_ratio > 0.10F) { // mannequins (white/grey) and hair
(black) are often vertically orientated
      multiplier−=0.1F;
      }
    }
  }
  if(getVariance( ) < .005F) {
    multiplier −= 0.1F;
  }
  if(vertical_ratio < −0.30F) {
    multiplier /= 3F;
  }
  if(multiplier < 0F) multiplier = 0F;
```

Error Correction Methods:

If the image only consists, primarily, of flesh/grey/black/white colors,—the multiplier can occasionally lower the scores of every ColorGroup, such that no ColorGroup has a high enough score to pass the minimum threshold. In this case, the score calculation for all ColorGroups can be repeated, with the flesh-penalty reduced.

Likewise, if the image only consists, primarily, of flesh/grey/black/white colors, then minor spot colors can end up being chosen as the most dominant color. In this case, we can remove the dominant flesh colors, and boost the position scores of the black/greyscale colors, such that these supercede the minor spot colors.

Note: some sets of images are not likely to have human models (e.g. shoes)—in these cases, the flesh penalties can be turned off for that image set. This may be sensed in some embodiments based on attributes of an image such as a keyword (e.g. shoe).

Removing Unused ColorGroups

At this point, the system is able to use the color group scores to remove under-performing ColorGroups. The system develops a cutoff value, which is set relative to the max_score of all the ColorGroups:

```
cutoff = .009F;
if(cutoff > max_score) {
    cutoff = max_score;
} else if(max_score > 0.16F) {
    cutoff = 0.02F;
} else if(max_score > 0.10F) {
        cutoff = 0.014F;
    }
All ColorGroups with scores below the max score are removed.
```

Also, the system calculates a cutoff for determining whether a color is “Primary” or “Secondary”. This is defined as the lower of the max_score/3 or 0.4. All ColorGroups with scores above this cutoff are “Primary,” all others are “Secondary”.

De-Duping

At this point, the system has the final set of precise colors+scores for each image. It is easy to now de-dupe the images—by finding any other images which have the same set of colors with nearly the same set of scores. This process works well, but only on images that are identical or near-identical. Images which have gone through different types of conversion filters may not match, for example, even though the images depict the same thing based on human perception.

Mapping ColorGroups to the ColorMap

For each image, the system stores the precise color (calculated from the average of all pixels within the group, one of 16 million colors) and score from each ColorGroup in a database. However, it may also be useful to map the ColorGroup's color to the ColorMap. A ColorMap is a list of discreet colors (far less then 16 million) that can, optionally, be associated with a name (Like “Blue” or “Crimson”). Each precise color can be matched to one or more colors in the color map.

The system may use one of two (or more) methods to match colors that work together:

Method 1: Brute Force.

For one embodiment, a set of 8,000 colors are picked as seed values and spread out strategically in the 3-dimensional color space (20 values each for red, green, blue—20×20×20=8000). For one such embodiment, more lighter colors then darker colors are chosen for each component, because the human eye can not distinguish dark colors as easily. For each of the 8,000 colors, manually chosen assignments are made to a “Common Color” (Black, Blue, Brown, Gold, Grey, Green, Orange, Pink, Purple, Red, Tan, Violet, White, Yellow) which most closely matches it. This approach, in the inventors' experience, works better than having an algorithm automatically choose colors, as the human eye does not behave in a simple linear fashion in terms of distinguishing colors. So, for any color among the 16 million possible values, the system simply finds the closest color of the 8,000 and then looks up the associated common color.

Method 2: Calculating color map matches.

Alternately, the system has a function which takes a precise color and generates a match score for every color in the color map—the score is based upon:

the difference of the color averages

the total of the absolute color difference for each component (red, green, blue)—with a correction for shading (differences among light values are increased, low values are decreased).

The total of the absolute differences between each component (red, green, blue) and each color's average (to account for shading)

The difference between the component ratios (red/green, green/blue, blue/red) for each color (also to account for shading)

All mapped colors which score (when compared to the precise color) less then a certain threshold are included. This threshold can, optionally, be specific to the type of color (for example, relatively common colors like “Navy Blue” can have a higher/less precise threshold, while very specific colors, like “Very Light Lemon Chiffon”, would have a much lower/more precise threshold. These values can be set by a human for each color or set automatically depending on where a color is a shaded version “Light/Dark” or extremely shaded “Very Light/Very Dark”).

All mapped colors scoring less then the threshold are included—however, when the brute force algorithm from above is applied to the map-color, it must match the same result as when applied to the precise color, else, the mapping is excluded. This helps to insure that the matches from method 2 are acceptable to the human eye.

The end result of this process is that the system now has, for each image, a set of both precise, scored colors, and a set of mapped colors from a color map. These values are stored in a database.

Color Searching

Creating a Query

Method 1: By Keyword:

In this method—the user types in the names of the colors they are searching for. A parser which parses this query, looks specially for:

(1) Color Names. These may be single words (“Blue”) or can span multiple words (“Army Green”). The names do not need to be an exact match. They can be misspelled, and the system can still perform a match.

(2) Light Dark Qualifiers: (e.g. “Light”, “Dim”, “Pale” or “Dark”, “Deep”, “Rich”). This allows the system to match “Pale Blue” to the Color-Map Color “Light Blue”.

(3) Extreme Qualifiers: (“Very”, “Extremely”). This allows the system to match “Really Dark Green” to the Color-Map Color “Very Dark Green”.

(4) Secondary Qualifiers (“Hint” “Drop” “Inkling”)—This allows the system to determine which colors the user intended as “Secondary-Only” colors. The user may have typed “Red with a hint of blue” or “Orange, but with a pink spot”) The parser finds all these keywords, and then outputs, a list of primary and secondary colors.

Method 2: Color Browsing

The system runs a query on the database to see how many images are connected to the Common Colors. (These counts can be stores in the database to improve performance, so they don't need to be calculated each search). The system simply displays the common colors and image counts, ordered by how many images map to each color. The user can simply click on a color—and then the color name is used as a keyword to feed into Method 1.

In addition to just the common colors—the system can also display a list of “All Colors”, sorted alphabetically and split into different sections for Light/Dark versions, for example.

Generating the Results

Once the system has a list of color-map colors, it's simple to perform a database query to find the matching images, using the mappings resulting from the indexing process. The harder problem is sorting the results, so that the best matches appear on top.

Sorting the Results

To sort the results, the system compares a number of criteria for each image:

(1) First, it shows images which matched the most colors of the query. If the query is “Red and Blue”, and image A matched both colors, and image B just matched Red, image A displays first. (Optionally, in a different section specially marked “Exact matches to all colors”)

(2) Next, show the image with the lower “Average Order”, where the average order differs by more then a set threshold. The “Order” is the order that a precise color appears in image's color set, sorted by score. The average order is the average across all (possibly multiple) color matches from the query.

(3) Next, show the image with the lower average accuracy, where the average accuracy differs by a set threshold. The accuracy refers to the difference between the precise color and the color-map color.

(4) Next, show the image with the lower Average Score, where the average score differs by a set threshold. The average score is the one calculating above from the indexing process—depends mostly on the number of pixels with this color, the position of those pixels, and the likelihood it represents a flesh/white/black/grey color.

(5) Next, show the image with the fewest number of total colors.

(6) Next, show the image with the lower average accuracy, where the average accuracy differs by a set threshold (lower threshold then above)

(7) Finally, show the image with the lower Average Score

In addition, the average click through rate (when randomly ordered) can be factored in, so that the images more likely to be displayed are clicked on first. Optionally, when there are enough matches (more then some threshold)—the system can filter out some percentage of matches from the end of the list (e.g. the last 30 percent)—so all matches “look good”.

Finding Related Colors

This is simply a matter of finding a list of all Color-Map colors which share the same Common Color (from the brute force method), ordering them by the number of matched images, and taking the top X to display. The set of related colors for each color-map color can be stored in advance in the database, so it doesn't need to be calculated for each search.

Finding Images Colored Like this One

The system starts with an image, and looks up the precise set of colors associated with that image. For each precise color, the system considers the best color-map color, where best is defined as the best combination of (A) high accuracy—close to the precise color, and (B) has the most matched images in the image set. The system then takes the color-map colors, and generates a query string using the names of the colors. This query then results in the set of matching images.

For commercial systems, some additional considerations may come into play. An operator can choose a set of products that appear as “defaults” when no query has been defined yet. Alternately, this can be the set of products with the highest click through rate.

It is possible to use an indexor on multiple images of the same product. Basically, use the same set of ColorGroups for multiple sets of images of the same product. This is especially useful on a site like Craigslist, where the photos are of low quality, but users often upload multiple photos of the same object (like, from different angles).

One skilled in the art will appreciate that although specific examples and embodiments of the system and methods have been described for purposes of illustration, various modifications can be made without deviating from the present invention. For example, embodiments of the present invention may be applied to many different types of databases, systems and application programs. Moreover, features of one embodiment may be incorporated into other embodiments, even where those features are not described together in a single embodiment within the present document.

What is claimed is:

1. A method, comprising:
receiving image data for an image;
calculating precise color values of the image data;
assigning precise color values of the image data to a set of predetermined discreet color values based on a mapping algorithm; and
storing a list of precise color values and discreet color values with data indicating a source of the image data.

2. The method of claim 1, further comprising:
organizing pixels of the image into groups based on color values of the pixels, with each color value of a pixel in a group visually matching color values of other pixels in the group.

3. The method of claim 2, further comprising:
filtering out fleshtone color values from pixel groups of the image.

4. The method of claim 2, further comprising:
filtering out background color values from pixel groups of the image.

5. The method of claim 2, further comprising:
filtering out greyscale color values from pixel groups of the image.

6. The method of claim 2, further comprising:
removing low-scoring color values from pixel groups of the image.

7. The method of claim 2, further comprising:
identifying a solid border of the image; and
ignoring pixels contained in the solid border.

8. The method of claim 2, further comprising:
merging multiple similar color groups into a single color group.

9. The method of claim 8, further comprising:
assigning a score to each color group.

10. The method of claim 9, wherein:
assigning a score to each color group depends on a position score derived from the average likelihood that all the pixels in the group are in the background of the image.

11. The method of claim 10, wherein:
determining the likelihood that a pixel is in the background of the image includes checking an absolute position of each pixel in the image and whether each pixel is contained in an automatically identified background area.

12. The method of claim 11, wherein:
the score of each color group depends on the number of pixels from the image contained within the group.

13. The method of claim 9, wherein:
the score of each color group depends on the average likelihood that the pixels in the group represent a flesh tone color.

14. The method of claim 9, wherein:
the score of each color group depends on the average likelihood that the pixels in the group represent a greyscale color.

15. The method of claim 9, wherein:
the score of each color group depends on the presence or absence of other flesh tone, background, or greyscale colors in the image.

16. The method of claim 2, further comprising:
converting color groups into a single precise scored color value, based on the color of all pixels contained in the group and the score of the group.

17. The method of claim 16, further comprising:
removing low scoring precise colors.

18. The method of claim 17, further comprising:
identifying identical or near-identical images from the image set by comparing each image's set of precise colors to every other image's set of precise colors; and
removing identical or near-identical images from the image set.

19. The method of claim 1, further comprising:
assigning all discreet color values to one color in a set of pre-determined commonly-used colors.

20. The method of claim 19, wherein:
The discreet color value assignments are chosen by an operator.

21. The method of claim 20, wherein:
The mapping from precise color to discreet color is performed by a machine.

22. The method of claim 21, wherein:
The mapping uses the assignments of discreet colors to commonly used colors.

23. The method of claim 21, wherein:
mapping includes comparing the absolute difference between the precise color and discreet color

24. The method of claim 21, wherein:
mapping includes comparing the shading difference between the precise color and discreet color.

25. The method of claim 21, wherein:
mapping includes comparing the relative ratios of red, green, and blue between the precise color and discreet color.

26. The method of claim 21, wherein:
mapping depends on a match threshold of each discreet color.

27. The method of claim 26, wherein:
the match threshold is determined by a type of the discreet color type.

28. The method of claim 26, wherein:
the match threshold is determined by an operator.

29. The method of claim 1, further comprising:
classifying color values from the list of precise color values as primary colors and secondary colors within the list of precise color values for the given image; and
applying these classifications to the mapped discreet colors.

30. The method of claim 1, further comprising:
aggregating the list of discreet color values into aggregated data of discreet color values across the set of images.

31. The method of claim 30, further comprising:
determining the frequency of occurrence of each discreet color value in the aggregated data of discreet color values for the entire set of images.

32. The method of claim 1, further comprising:
limiting the list of discreet color values to a predetermined maximum number of entries; and
removing low-scoring color values from the list of precise color values.

33. The method of claim 32, further comprising:
filtering out fleshtone color values from the list of precise color values;
filtering out background color values from the list of precise color values; and
filtering out greyscale color values from the list of precise color values.

34. The method of claim 1, further comprising:
aggregating the list of discreet color values into aggregated data of discreet color values for a set of other images; and
comparing the list of discreet color values to aggregated data of discreet color values for a set of other images.

35. The method of claim 34, further comprising:
determining the most frequently occurring discreet color values in the aggregated data of discreet color values for a set of other images.

36. The method of claim 35, further comprising:
determining the most frequently selected discreet color values in the aggregated data of discreet color values for a set of other images.

37. The method of claim 1, further comprising:
searching the list of discreet color values for a user-specified discreet color value; and
matching the user-specified discreet color value to a discreet color value of the list of discreet color values.

38. The method of claim 37, further comprising:
retrieving the image associated with the list of discreet color values; and
presenting the image associated with the list of discreet color values to a user.

39. A method, comprising:
receiving image data for an image;
inventorying color values of the image data;
assigning color values of the image data to a set of predetermined discreet color values based on distance of a color value from a discreet color value to provide a list of discreet color values;
limiting the list of discreet color values to a predetermined maximum number of entries;
removing low-scoring color values from the list of discreet color values;
filtering out fleshtone color values from the list of discreet color values;
filtering out background color values from the list of discreet color values;
filtering out greyscale color values from the list of discreet color values.
classifying color values from the list of discreet color values as primary colors and secondary colors within the list of discreet color values.
storing a list of discreet color values with data indicating a source of the image data;
aggregating the list of discreet color values into aggregated data of discreet color values for a set of other images; and
comparing the list of discreet color values to aggregated data of discreet color values for a set of other images.

40. A machine-readable medium embodying instructions, the instructions, when executed by a processor, causing the processor to perform a method, the method, comprising:
receiving image data for an image;
inventorying color values of the image data;
assigning color values of the image data to a set of predetermined discreet color values based on distance of a color value from a discreet color value to provide a list of discreet color values; and
storing the list of discreet color values with data indicating a source of the image data.

41. The machine-readable medium of claim 40, wherein the method further comprises:
limiting the list of discreet color values to a predetermined maximum number of entries; and
removing low-scoring color values from the list of discreet color values.

42. The machine-readable medium of claim 41, wherein the method further comprises:
filtering out fleshtone color values from the list of discreet color values;
filtering out background color values from the list of discreet color values; and
filtering out greyscale color values from the list of discreet color values.

43. The machine-readable medium of claim 42, wherein the method further comprises:
classifying color values from the list of discreet color values as primary colors and secondary colors within the list of discreet color values.

44. The machine-readable medium of claim 40, wherein the method further comprises:
aggregating the list of discreet color values into aggregated data of discreet color values for a set of other images; and
comparing the list of discreet color values to aggregated data of discreet color values for a set of other images.

45. The machine-readable medium of claim 44, wherein the method further comprises:
determining the most frequently occurring discreet color values in the aggregated data of discreet color values for a set of other images.

46. The machine-readable medium of claim 45, wherein the method further comprises:
determining the most frequently selected discreet color values in the aggregated data of discreet color values for a set of other images.

47. The machine-readable medium of claim 40, wherein the method further comprises:
searching the list of discreet color values for a user-specified discreet color value; and
matching the user-specified discreet color value to a discreet color value of the list of discreet color values.

48. The machine-readable medium of claim 47, wherein the method further comprises:
retrieving the image associated with the list of discreet color values; and
presenting the image associated with the list of discreet color values to a user.

49. The machine-readable medium of claim 40, wherein the method further comprises:
limiting the list of discreet color values to a predetermined maximum number of entries;
removing low-scoring color values from the list of discreet color values.
filtering out fleshtone color values from the list of discreet color values;
filtering out background color values from the list of discreet color values;
filtering out greyscale color values from the list of discreet color values;
classifying color values from the list of discreet color values as primary colors and secondary colors within the list of discreet color values;
aggregating the list of discreet color values into aggregated data of discreet color values for a set of other images; and
comparing the list of discreet color values to aggregated data of discreet color values for a set of other images.

50. A system, comprising:
a processor;
a memory coupled to the processor;
a user interface coupled to the processor;
a network interface coupled to the processor;
wherein the system is to:
receive image data for an image;
inventory color values of the image data;
assign color values of the image data to a set of predetermined discreet color values based on a mapping algorithm to provide a list of discreet color values; and
store the list of discreet color values with data indicating a source of the image data.

51. The system of claim 50, wherein the system is further to:
search the list of discreet color values for a user-specified discreet color value; and
match the user-specified discreet color value to a discreet color value of the list of discreet color values.

52. The system of claim 51, wherein the system is further to:
retrieve the image associated with the list of discreet color values; and
present the image associated with the list of discreet color values to a user.

53. The system of claim 50, wherein the system is further to:
limit the list of discreet color values to a predetermined maximum number of entries; and
remove low-scoring color values from the list of discreet color values.

54. The system of claim 53, wherein the system is further to:
filter out fleshtone color values from the list of discreet color values;
filter out background color values from the list of discreet color values; and
filter out greyscale color values from the list of discreet color values.

55. The system of claim 54, wherein the system is further to:
classify color values from the list of discreet color values as primary colors and secondary colors within the list of discreet color values.

56. The system of claim 50, wherein the system is further to:
aggregate the list of discreet color values into aggregated data of discreet color values for a set of other images; and
compare the list of discreet color values to aggregated data of discreet color values for a set of other images.

57. The system of claim 56, wherein the system is further to:
determine the most frequently occurring discreet color values in the aggregated data of discreet color values for a set of other images.

58. The system of claim 57, wherein the system is further to:
determine the most frequently selected discreet color values in the aggregated data of discreet color values for a set of other images.

59. The system of claim 50, further comprising:
means for interacting with a database.
